(19) United States
(12) Patent Application Publication
(10) Pub. No.: US 2008/0059027 A1
(43) Pub. Date: Mar. 6, 2008

(54) Methods and apparatus for classification of occupancy using wavelet transforms

(76) Inventors: Michael E. Farmer, Clarkston, MI (US); Shweta R. Bapna, Clarkston, MI (US)

Correspondence Address: Martin J. Jaquez, Esq.;JAQUEZ & ASSOCIATES, Suite 100D, 6265 Greenwich Drive, San Diego, CA, 92122, US

(21) Appl. No.: 11/514,299

(22) Filed: Aug. 31, 2006

(51) Int. Cl. B60R 22/00

(52) U.S. Cl. 701/45; 280/735; 180/273

(57) ABSTRACT

Improved methods and apparatus for classifying occupancy of a position use wavelet transforms, such as Gabor filters, for processing images obtained in conjunction therewith. For example, a computer system comprises an algorithm that utilizes a wavelet transform for processing of imagery associated with a position in order to classify occupancy of that position. A method comprises steps of: obtaining an image of the position; optionally segmenting the image at the position; optionally dividing the image into multiple key regions for further analysis; analyzing texture of the image using one or more wavelet transforms; and classifying occupancy of the position based on the texture of the image.

### BACKGROUND

The disclosed methods and apparatus generally relate to methods and apparatus for classifying occupancy of a position using image analysis, and more specifically to those methods and apparatus using wavelet transforms, such as Gabor filters, for processing images obtained in conjunction therewith.

Automated safety systems (e.g., airbag deployment systems) are commonplace in modern vehicles, such as automobiles. With increased knowledge about automated safety systems, it has been observed that occupant safety may be enhanced by conditioning vehicle protective feature (e.g., airbag) deployment upon information regarding the occupant to be protected. For example, it is widely understood that certain occupants, which are rather small in size and low in weight, are better served by suppressing airbag deployment during accidents, or by reducing the rate or force of that airbag deployment. Even with larger occupants, it is often desirable, particularly under certain driving conditions, to reduce deployment force or rate, or even to preclude airbag deployment entirely, such as when the larger occupant is positioned such that ordinary airbag deployment might cause harm to the occupant.

Threshold criteria for deployment of vehicle protective features may be based on conditions relevant to the vehicle. Such criteria might be provided, for example, when the vehicle is decelerating in a manner suggesting that the safety of an occupant may be in jeopardy. Criteria relevant to conditions of the vehicle, as opposed to criteria relevant to conditions specific to an occupant, may thus be used to reach an initial decision pertaining to protective feature deployment. As an example, vehicle-relevant criteria might be used to limit deployment rate, or force the deployment rate below a default or selected level.

Modern airbag deployment systems may also condition deployment of airbags on information related to current conditions of a vehicle occupant. A variety of techniques have been described in the literature for obtaining information about an occupant, upon which such further deployment conditioning may be based. In particular, some techniques “classify” occupants into one of two or more classes and estimate current occupant position and/or occupant movement. Occupants may be classified, for example, as being an “infant,” a “child,” an “adult,” or “empty.” Airbag deployment may then be conditioned upon such occupant classification, for example, by reducing the rate or force of airbag deployment, or precluding airbag deployment altogether, for occupants of one class (e.g., “child”) as compared to occupants of another class (e.g., “adult”).

Regarding occupant position and movement, it has been found desirable in some vehicle safety systems to condition airbag deployment (and deployment of other safety and security mechanisms) upon such information, so that an occupant positioned in close proximity to an airbag when the airbag might deploy, for example, is not inadvertently harmed by rapid airbag expansion. The following commonly assigned and co-pending patent applications are hereby incorporated by reference in their entirety for their teachings of such exemplary vehicle safety systems: U.S. patent application Ser. No. 11/157,465, by Farmer, entitled “Vehicle Occupant Classification Method and Apparatus for Use in a Vision-Based Sensing System,” filed Jun. 20, 2005, and U.S. patent application Ser. No. 11/157,466 by Farmer et al., entitled “Improved Pattern Recognition Method and Apparatus for Feature Selection and Object Classification,” filed Jun. 20, 2005.

In order to obtain information about vehicle occupants, one or more sensors are typically used in airbag deployment systems. In particular, imaging sensors are often employed in order to obtain information pertaining to vehicle occupants and vehicle conditions. Various proposals have been set forth for enabling a vehicle airbag control system and conditioning airbag deployment upon information obtained by the sensors. The following commonly assigned patent applications and issued patents are hereby incorporated by reference in their entirety for their teachings in this regard: U.S. Patent Publication No. 20030016845A1, entitled “Image Processing System for Dynamic Suppression of Airbags Using Multiple Model Likelihoods to Infer Three Dimensional Information;” U.S. Patent Publication No. 20030040859A1, entitled “Image Processing System for Detecting When An Airbag Should Be Deployed;” U.S. Pat. No. 6,459,974, entitled “Rules-Based Occupant Classification System for Airbag Deployment;” U.S. Pat. No. 6,493,620, entitled “Motor Vehicle Occupant Detection System Employing Ellipse Shape Models and Bayesian Classification;” and U.S. Patent Publication No. 20060056657A1, entitled “Single Image Sensor Positioning Method And Apparatus In A Multiple Function Vehicle Protection Control System.”

In addition to the aforementioned, various other solutions to the problem of automated deployment of safety equipment have been proposed including, inter alia, solutions using manual switching or weight sensors. One example of a manual switching solution involves manually disabling a particular safety system, such as an airbag, if a child or infant is potentially at risk of injury. A problem with such a disabling mechanism is that the operator may forget to enable the safety system once the child or infant is no longer at risk. Under such circumstances, a subsequent adult passenger who might otherwise benefit from the safety system, such as an airbag, will not have that benefit.

Weight sensors have also been used in other automated safety systems. Such a solution senses the weight of a passenger and automatically deploys or suspends safety equipment. Typically, a fluid bladder is installed underneath the passenger seat to detect the weight of the passenger. This approach is often inadequate since such systems typically offer only two levels of protection, for example, a level of protection for either a big object or a small object. Hence, a passenger having a weight that does not correspond to these two protection levels may be injured. Furthermore, because the sensor is placed underneath the passenger seat, configuration of the passenger seat cushioning and/or passenger movement can detrimentally affect the accuracy of the system and/or comfort of the seat.

Methods for extracting information regarding the texture of an image are known. An example of such a method uses wavelet transforms, one of which operates based on well known Gabor filters. Gabor filters have been used in detecting fingerprints; detecting facial expressions as described in, for example, U.S. Pat. No. 6,964,023; general object detection as described in, for example, U.S. Pat. No. 6,961,466; vehicle control systems focusing on collision avoidance as described in, for example, U.S. Pat. No. 6,847,894; monitoring subjects in vehicle seats as described in, for example, U.S. Pat. No. 6,506,153; certain aspects of vehicle passenger restraint systems as described in, for example, U.S. Pat. No. 5,814,897; and a variety of medical and other applications.

Due to the desire for refinements to automated safety systems in view of their important safety function, methods for improving processing of information obtained in that regard are needed. Such methods and apparatus employing the same should be compatible with other components of automated safety systems in use today.

### SUMMARY

The present teachings provide improved methods and apparatus for classifying occupancy (e.g., the presence or absence of an occupant in a vehicle) and processing images obtained in conjunction therewith. In an exemplary embodiment, methods and apparatus are applied to improve automated safety systems, such as, for example, airbag deployment systems in passenger vehicles.

According to this exemplary embodiment, classifying occupancy of a position within the vehicle includes determining when there is no occupant (e.g., in the case of an “empty” vehicle seat) or a relevant occupant (e.g., in the case of an “occupied” vehicle seat). The described methods and apparatus are compatible with other components of automated safety systems in use today.

A computer system of the invention comprises an algorithm for processing of imagery associated with a position to be analyzed, wherein the imagery is processed to classify occupancy of that position, and wherein the algorithm utilizes a wavelet transform in processing of the imagery. The position analyzed is a vehicle seat in an exemplary embodiment. The computer system can be part of an automated safety system, for example, an airbag deployment system. A number of well known components can be included with computer systems of the invention in such automated safety systems. Exemplary components include image-based sensing equipment, an electronic control unit for selective deployment of safety equipment, and safety equipment such as an airbag.

According to one aspect of the invention, the algorithm of the computer system uses spatial filtering for processing of the imagery. According to a further aspect of the invention, the wavelet transform comprises at least one Gabor filter. The imagery can be further processed used a variety techniques. For example, according to one embodiment, processing of the imagery comprises using statistical analysis of feature vectors derived from the wavelet transform. As an example, the statistical analysis can comprise use of histograms, wherein histograms associated with classification of the position as empty are narrow and focused as compared to histograms being associated with classification of the position as occupied, which are broader and more uniformly distributed.

A method for classification of occupancy at a position comprises steps of: obtaining an image of the position for use in classification of the occupancy at that position; optionally segmenting the image at the position; optionally dividing the image into multiple key regions for further analysis; analyzing texture of the image using one or more wavelet transforms; and classifying occupancy of the position based on the texture of the image. The position is a seat within a vehicle according to an exemplary embodiment. The occupancy of the position can be assigned a classification of “empty” or “occupied.”

According to one aspect of the method of the invention, the step of analyzing texture of the image comprises using a bank of Gabor filters. Gabor filter coefficients from the bank of Gabor filters can be used to form a feature vector. According to a further aspect of the invention, statistical analysis is performed on the feature vector. The statistical analysis can include, for example, use of histograms, wherein histograms associated with classification of the position as empty are narrow and focused as compared to those histograms associated with classification of the position as occupied, which are broader and more uniformly distributed. In a further embodiment, information associated with the classification is transmitted to an electronic control unit (e.g., an airbag controller).

### BRIEF DESCRIPTION OF THE DRAWINGS

FIG. 1 illustrates a partial view of a vehicle environment and data processing system that can be used in one embodiment of the present methods and apparatus.

FIG. 2 is a flow diagram illustrating processing of an image according to an exemplary embodiment of the described methods and apparatus.

FIG. 3 is a segmented image of an empty vehicle seat.

FIG. 4 is a segmented image of a vehicle seat occupied by an infant in a rear-facing car seat.

FIG. 5A illustrates a sampled image of a vehicle seat occupied by an adult.

FIG. 5B illustrates a segmented image of the sampled image of a vehicle seat occupied by an adult illustrated in FIG. 5A.

FIG. 6 is a segmented image of an empty vehicle seat with key regions identified therein.

FIG. 7A illustrates the real part of a bank of Gabor filters with three scales and four orientations as used according to one embodiment of the present methods and apparatus.

FIG. 7B illustrates the imaginary part of a bank of Gabor filters with three scales and four orientations as used according to one embodiment of the present methods and apparatus.

### DETAILED DESCRIPTION

Automated safety systems are employed in a growing number of vehicles. An exemplary embodiment set forth below is employed in the context of a passenger vehicle having an airbag deployment system. The skilled person will understand, however, that the principles set forth herein may apply to other types of vehicles using a variety of safety systems. Such types of vehicles include, inter alia, aircraft, spacecraft, watercraft, and tractors.

Moreover, although the exemplary embodiment employs an airbag in the exemplary safety system, the skilled person will recognize that the method and apparatus described herein may apply to widely varying safety systems inherent in the respective vehicle to which it is applied. In particular, a method or apparatus as described herein may be employed whenever it is desired to obtain advantages of automated safety systems requiring accurate classification of vehicle occupancy.

Accurate occupancy classification enhances the ability of automated safety systems to select appropriate safety equipment and determine appropriate use parameters for the selected equipment under the then-current conditions. In the exemplary embodiment described throughout, the automated safety system comprises an airbag deployment system. In this embodiment, if the occupancy classification is “empty,” the airbag would typically not be selected for deployment. However, if the occupancy classification is “occupied” (e.g., in the case of occupancy by an “adult,” “infant,” or “child”), the airbag may be selected for deployment under emergency conditions (e.g., a vehicle crash) or when otherwise desired upon further differential analysis according to knowledge of those skilled in the art.

Other embodiments include application of methods and apparatus in conjunction with various types of safety mechanisms triggered by an automated safety system. For example, a vehicle door may be selected to lock or unlock automatically under a specified emergency condition, such as, for example, in the event of a vehicle crash. As another example, the automated safety system may detect when a vehicle is underwater and deploy appropriate safety equipment, such as, for example, opening vehicle windows and/or deploying floatation devices. Other non-limiting examples of automated safety equipment include Global Positioning System (GPS) devices and other types of broadcasting mechanisms, traction systems that aid when encountering difficult terrains, and systems for re-directing shockwaves caused by vehicle collisions.

The present methods and apparatus obtain information about an environment and subsequently process the information to provide a highly accurate classification regarding occupancy. In the exemplary embodiment described in more detail below, occupancy of a position within a vehicle (e.g., a vehicle seat) is analyzed and classified using image-based sensing equipment.

According to one exemplary embodiment, occupancy of a vehicle seat is analyzed and classified for automated safety system applications, such as airbag deployment systems. Four classes of occupancy are often used in conjunction with airbag deployment systems. Those four classes are: (i) “infant,” (ii) “child,” (iii) “adult,” and (iv) “empty” seat. Accurate occupant classification has proven difficult in the past due to many factors including: vehicle seat variations; changing positions of occupants within seats; occupant characteristics such as height and weight; and the presence of extraneous items such as blankets, handbags, shopping bags, notebooks, documents, and the like. The present methods and apparatus improve the accuracy of occupant classification, particularly as it relates to differentiation between when a seat is “empty” or “occupied.”

According to one aspect of an exemplary embodiment, an image of a vehicle seat is analyzed to determine whether the seat is “empty” or “occupied.” Although the term “empty” is often associated with the absence of any object whatsoever in the vehicle seat, the term “empty” is used herein to indicate that no animate occupant (e.g., human or animal) is present in the vehicle seat. The presence of relatively small, inanimate objects, such as handbags, shopping bags, notebooks, documents, and the like, that are often placed on a vehicle seat when it is not occupied by a passenger, does not generally prevent a seat from being classified as “empty.” While the presence of relatively large, inanimate objects may trigger classification of a vehicle seat as “occupied,” the present method and apparatus distinguishes between occupancy by the more common relatively small, inanimate objects, and occupancy by an animate form. If the presence of a larger inanimate object results in classification of the seat as “occupied,” the object may be analyzed in more detail according to further embodiments of the invention (e.g., using methods for differentiating between occupancy by an “infant,” “child,” or “adult” as known to those of ordinary skill in the art. For example, such methods and apparatus include those described in U.S. Pat. Nos. 6,662,093; 6,856,694; and 6,944,527, all of which are hereby incorporated by reference for their teachings on methods and apparatus for differentiating between occupancy classifications.

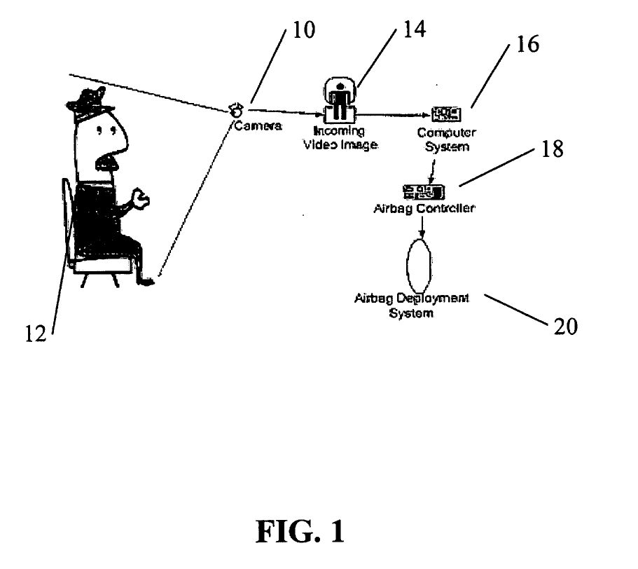

FIG. 1 illustrates a partial view of a vehicle environment and data processing system that can be used in one embodiment of the present method and apparatus. It is to be understood that each of the components represented separately in FIG. 1 may be integral with one or more of the other components. Thus, although the components appear to be physically separated and discrete in the illustration shown in FIG. 1, one or more of the components may be combined in one physically integrated component having multiple functionalities.

As shown in FIG. 1, in one embodiment, a camera 10 captures images from a vehicle interior at a predetermined rate. In particular, the camera 10 obtains images of the vehicle seat 12. In one exemplary embodiment, the camera 10 is positioned in the roof liner of the vehicle along a vehicle center-line, and near the edge of the windshield. This positioning of the camera 10 provides a near profile view of the vehicle seat 12, which aids in accurate occupancy classification of the vehicle seat 12. This camera positioning also reduces the likelihood that any occupant of the vehicle seat 12 will inadvertently block the view of the camera 10. The typical field of view required for most passenger vehicles is approximately 100 degrees vertical Field of View (FOV) and approximately 120 to approximately 130 degrees horizontal FOV. This FOV ensures full image coverage of the vehicle seat 12, whether it is positioned near the instrument panel or in the rear-most seating position (e.g., when the vehicle seat 12 is fully reclined).

Incoming images 14 (in the exemplary embodiment, video images) are transmitted from the camera 10 to any suitable computer-based processing equipment, such as a computer system 16. As described in more detail below, the computer system 16 determines occupancy classification of the vehicle seat 12 and transmits the occupancy classification to an electronic control unit 18 (in this embodiment, an airbag controller) in the event of an emergency or when otherwise desired. Subsequently, in the exemplary embodiment, an airbag deployment system 20 responds to the airbag controller 18, and either deploys or suppresses deployment of an airbag based upon occupant classification of the vehicle seat 12 and other factors as desired. A variety of airbag controllers and airbag deployment systems are known to those skilled in the art and can be used in accordance with the present invention.

The computer system 16 processes images of the vehicle seat 12 obtained from the camera 10. According to one embodiment, processing of the images is implemented using wavelet transforms (e.g., Gabor filters) as described in more detail below. Any suitable computer system can be used to implement the present methods and apparatus according to operating principles known to those skilled in the art. In an exemplary embodiment, the computer system 16 includes a digital signal processor (DSP). The DSP is capable of performing image processing functions in real-time. The DSP receives pixels from the camera 10 via its Link Port. The DSP is responsible for system diagnostics and for maintaining communications with other subsystems in the vehicle via a vehicle bus. The DSP is also responsible for providing an airbag deployment suppression signal to the airbag controller 18.

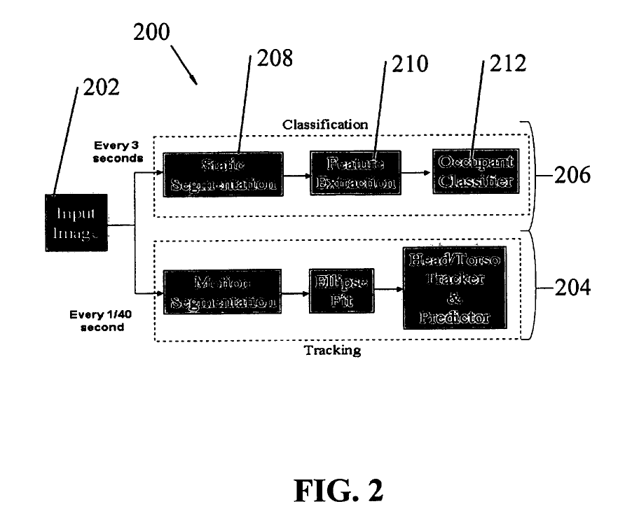

According to this exemplary embodiment, the computer system 16 processes an image obtained from the camera 10 using several steps. A flow diagram 200 of the image processing steps according to this exemplary embodiment is illustrated in FIG. 2. According to FIG. 2, an “Input Image” 202 is conveyed to the computer system and processed to determine occupancy classification of the vehicle seat according to the present teachings. The vehicle seat occupant classification can be determined any desired number of times and at any desired frequency (at regular or irregular intervals). In the exemplary embodiment illustrated in FIG. 2, the Input Image 202 is processed in this manner approximately once every 3 seconds.

Note that the flow diagram 200 of FIG. 2 also includes optional motion tracking steps 204 according to a further embodiment of the disclosed methods and apparatus. Those skilled in the art are readily familiar with suitable motion tracking steps that could be included in further embodiments. Techniques and apparatus associated with the optional motion tracking steps are described in, for example, U.S. Patent Publication No. 20030123704A1, entitled “Motion-Based Image Segmentor for Occupant Tracking,” which is hereby incorporated by reference for its teachings on methods and apparatus for motion tracking. In the exemplary further embodiment illustrated in FIG. 2, the “Input Image” 202 is conveyed to the computer system and processed using motion tracking steps 204 about once every 1/40^{th} of a second.

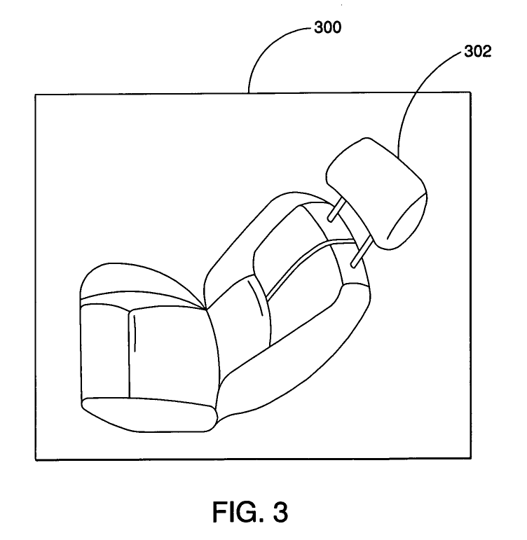

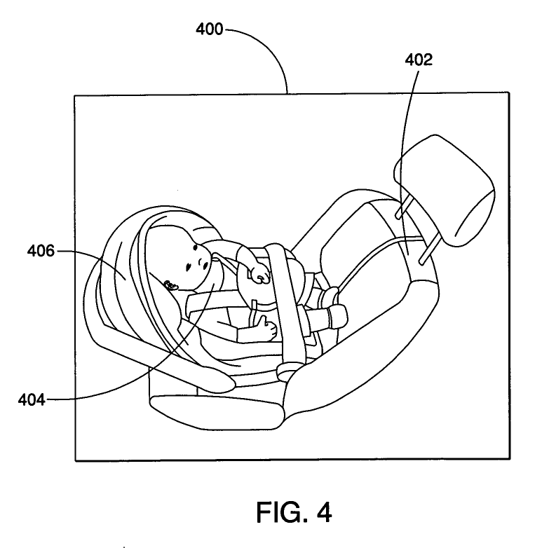

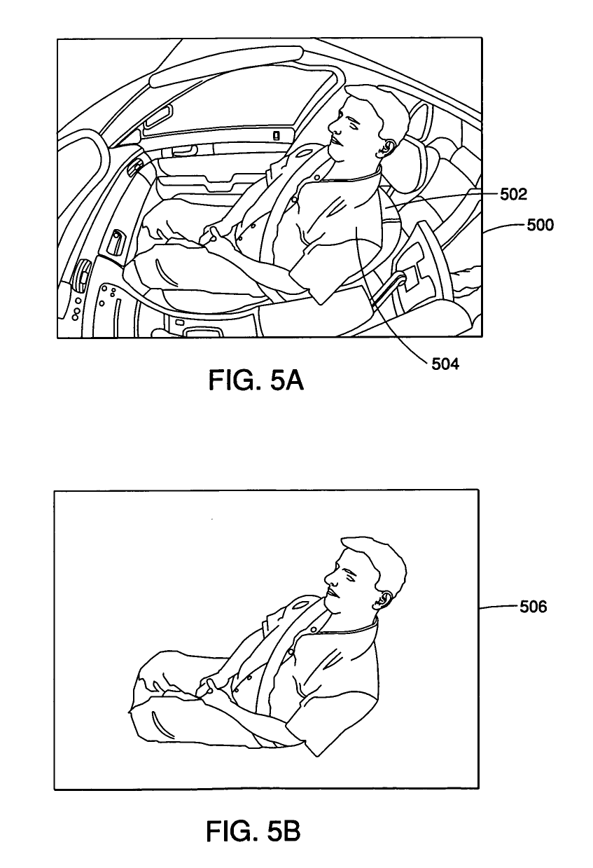

The Input Image 202 is first segmented according to the classification process steps 206. In the flow diagram of FIG. 2, the first segmentation step is referred to as a “Static Segmentation” step 208. Segmentation primarily removes parts (i.e., pixels) of the image other than the vehicle seat and any occupant of the seat. The resulting image is referred to as a “segmented image.” A number of well known methods can be used to obtain segmented images in this manner. For example, segmentation methodology is described in U.S. Patent Publication No. 20030031345A1, entitled “Image Segmentation System and Method,” which is hereby incorporated by reference for its teachings on image segmentation. Segmented images related to various classifications are illustrated in FIGS. 3 to 5. FIG. 3 comprises a segmented image 300 of an empty vehicle seat 302. FIG. 4 comprises a segmented image 400 of a vehicle seat 402 occupied by an infant 404 in a rear-facing car seat 406. FIG. 5A comprises a sampled image 500 of a vehicle seat 502 occupied by an adult 504. For comparison, FIG. 5B illustrates the resulting segmented image 506 of the vehicle seat 502 occupied by the adult 504 shown as a sampled image 500 in FIG. 5A.

Segmentation alone has not proven sufficient for providing accurate and reliable occupancy classifications. One reason for this shortcoming is that small occupants (e.g., infants and children) typically fit within the boundaries of the vehicle seat and often do not appear any different than an empty seat when viewed in relation to the perimeter of the vehicle seat. Another reason for this shortcoming is that, even when the occupant of a vehicle seat is an adult, it can be difficult to accurately classify the occupant by analyzing the shape of the vehicle seat in a segmented image. The shape of an average adult male is typically used as a template for designing the shape of the vehicle seat; thus, the perimeter of a vehicle seat may have a shape approximating that of many adult occupants. Therefore, a further step according to the present methods and apparatus relies on textural analysis of the features within a segmented image. As shown in FIG. 2, a “Feature Extraction” step 210 follows image segmentation in an exemplary embodiment. During feature extraction, one or more key regions are analyzed within the segmented image. This analysis facilitates occupancy classification.

According to this aspect of the invention, texture of a segmented image is analyzed using one or more wavelet transforms. This analysis is particularly useful for differentiating between an “empty” occupant classification and other “occupied” classifications, such as those where an animate form (e.g., person) is positioned within the area being analyzed. In particular, note that an empty seat typically has very little texture variance throughout, except for in areas where there is, for example, stitching or another type of variation in the exterior covering (e.g., leather or fabric of the seat). As described in more detail below, analysis of texture variance was found to be a useful tool in classifying between an “empty” seat and a seat that is “occupied” by some animate form of occupant (e.g., a human occupant).

The number, size, and location of key regions for feature extraction are selected based on a predetermined number of processing windows. For example, at least three or four distinct key regions may be used in conjunction with methods and apparatus exemplified herein. Each key region facilitates localized analysis of the texture of the segmented image. The key regions can overlap, partially or fully, with one or more adjacent key regions in one embodiment of the present methods and apparatus. However, the key regions need not overlap to any extent in other embodiments.

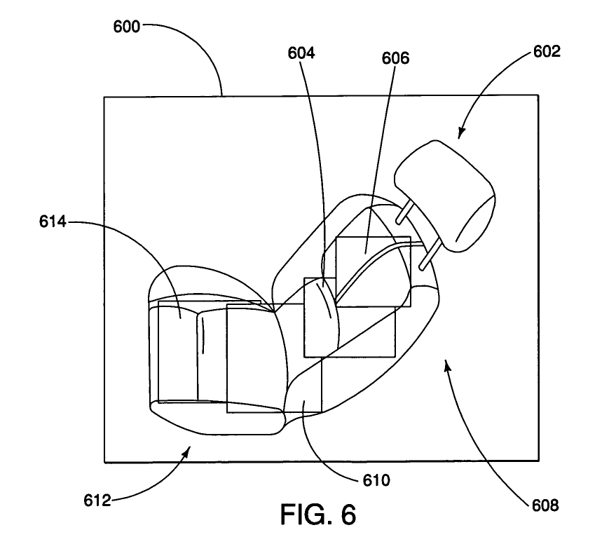

Four key regions are illustrated in the exemplary segmented image 600 shown in FIG. 6. According to this exemplary embodiment where the key regions are associated with a vehicle seat 602, key regions include one or more portions 604, 606 on the back 608 of the vehicle seat 602, one or more portions 610 extending between the back 608 of the vehicle seat 602 and the bottom 612 of the vehicle seat 602, and one or more portions 614 on the bottom 612 of the vehicle seat 602. It is to be understood, nevertheless, that the number, size, and location of key regions will vary depending on the particular application and preferences and is, thus, understood to be adjustable.

After key regions are identified, representative texture of each of the key regions is assessed using a wavelet transform. An exemplary wavelet transform comprises a bank of multi-dimensional Gabor or similar texture filters or matrices. While Gabor filters were found to provide superior performance, a number of other texture filters and matrices are known and can be adapted for use according to the present invention. For example, two-dimensional Fourier transforms (although lacking in their comparative ability to analyze orientation in addition to frequency), co-occurrence matrices, and Haar wavelet transforms (which are based on step functions of varying sizes as compared to Gaussian functions) are a few examples of other tools useful for texture analysis. Any suitable texture analysis methods and apparatus, including combinations thereof, can be used. For example, it is to be understood that a combination of image filters relying on wavelet transforms can be used according to further embodiments. It is also to be understood that more than one wavelet transform can be applied to a particular key region or portion thereof. Such might be the case for desired redundancy or other purposes.

As with other wavelet transforms, the exemplary Gabor filter advantageously combines directional selectivity (i.e., detects an edge having a specific direction), positional selectivity (i.e., detects an edge having a specific position) and a spatial frequency selectivity (i.e., detects an edge whose pixel values change at a specific spatial frequency) within one image filter. The term “spatial frequency”, as used herein, refers to a level of a change in pixel values (e.g., luminance) of an image with respect to their positions. Texture of an image is defined according to spatial variations of grayscale values across the image. Thus, by assessing the spatial variation of an image across a key region using a Gabor filter or equivalent wavelet transform, texture of the image within the key region can be defined. According to one embodiment, texture is defined in accordance with the well known Brodatz texture database. Reference is made to P. Brodatz, Textures: A Photographic Album for Artists and Designers, (1966) Dover, N.Y.

Each Gabor filter within a multi-dimensional Gabor filter bank is a product of a Gaussian kernel and a complex plane wave as is well known to those skilled in the art. As used, each Gabor filter within the bank varies in scale (based on a fixed ratio between the sine wavelength and Gaussian standard deviation) and orientation (based on the sine wave).

According to the present methods and apparatus, Gabor filter coefficients (which are complex in that they include both a real part and an imaginary part) are computed for each of the Gabor filters within a bank of Gabor filters for each position under analysis. The coefficient of each Gabor filter that corresponds to the feature vector element is a measure of the likelihood that the associated key region is dominated by texture associated with that given directional orientation and frequency of repetition. A multi-dimensional Gabor filter bank is represented according to the following Equation I:

Gabor(x;k₀,C)=exp(ix·k₀)G(x;C) Equation I

As used in Equation I, the term “k₀” is the wave number associated with the exponential function of which it is a part; and, the term “k₀” dictates the frequency of the sinusoid associated with the exponential in Equation I. As used in Equation I, “x” represents the vector associated with that specific Gabor filter within the bank. The term “G(x; C)” represents the two-dimensional Gaussian kernel with covariance “C.” That Gaussian kernel is represented according to the following Equation II:

$$Equation II \text{:}$$

$$G ( x , C ) = \frac{1}{{( 2 π )}^{d / 2} \vert C \vert} \cdot exp ( - \frac{1}{2} {x}^{T} {C}^{- 1} x )$$

As applied to an exemplary embodiment of the disclosed methods and apparatus, in Equation II, “d” is assigned a value of two based on two-dimensional spatial filtering according to the invention and “T” refers to the transpose of vector “x.” For a two-dimensional row and column vector “x,” which has one column and two rows, the transpose “T” has two columns and one row. The remaining terms are as defined herein.

In one embodiment, a bank of two-dimensional Gabor filters is used to spatially filter the image within each key region. As a general principle, spatial filtering using Gabor filters is understood by those of skill in the art, despite Gabor filters having not been applied as in the present methods and apparatus. In spatially filtering an image, a feature vector is created from the bank of Gabor filters. Analysis of the bank of Gabor filters, and the resultant feature vector, provides a description of the texture (e.g., as represented by amplitude and periodicity) of the image in that the key region being analyzed based on an estimate of the phase responses of the image within the analyzed key region.

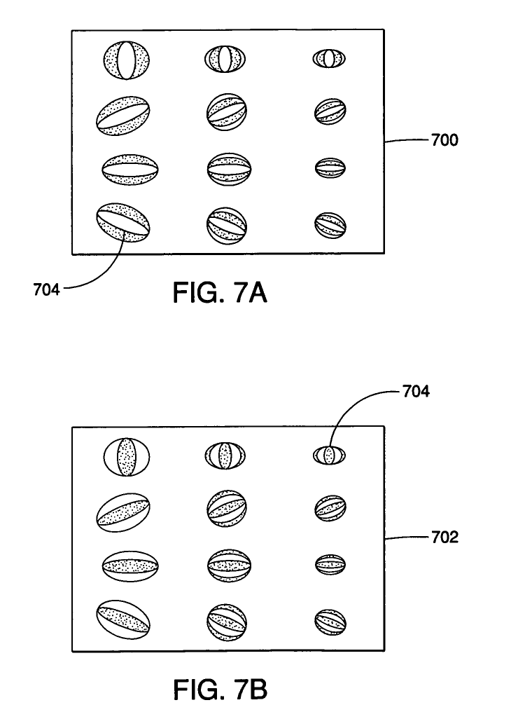

FIGS. 7A and 7B illustrate a bank of Gabor filters with three scales and four orientations, FIG. 7A representing the real part 700 of the bank of Gabor filters and FIG. 7B representing the imaginary part 702 of the bank of Gabor filters. In this particular embodiment, each Gabor filter 704 (note that only one of the twelve Gabor filters is identified by reference identifier 704 in each of FIGS. 7A and 7B) within the bank is oriented in a particular direction (i.e., every 45 degrees) and the oscillations of each filter are relatively compact. The resulting feature vector for each bank of Gabor filters contains twelve elements, each element corresponding to the covariance, C, calculated for the Gabor filter 704 within the multi-dimensional Gabor filter bank.

After being organized into a feature vector, pattern recognition is performed to determine classification of the analyzed position. This pattern recognition step corresponds to the “Occupant Classifier” step 212 of FIG. 2. Those of ordinary skill in the art will readily recognize that a number of suitable methods may be used in implementing this pattern recognition step. In one embodiment, the pattern to be recognized is either that of an “empty” seat or an “occupied” seat. According to a further exemplary embodiment, if a seat is classified as “occupied,” it can be analyzed for more detail using any of a number of methods for differentiating between occupancy by an “infant,” “child,” or “adult.” Such methods are described in, for example, U.S. Pat. Nos. 6,662,093; 6,856,694; and 6,944,527. As discussed above, when a large inanimate object results in classification of a seat as “occupied,” these methods for further analysis can beneficially be used for assisting in a determination of how to respond.

According to an exemplary embodiment, pattern recognition is facilitated using histograms. According to this embodiment, histograms are generated for each of the elements of the particular feature vector as known to those skilled in the image processing arts. Histograms generated according to this step serve as statistical tools for determining the most common texture in each key region under analysis.

When analyzing one or more key regions for classification of a vehicle seat as “empty” or “occupied,” histograms associated with key regions within an “empty” vehicle seat will generally be distinguished by relative spikiness as compared to those key regions within an otherwise “occupied” vehicle seat. The spikes in the histogram generally correspond to angles and spacing of a textural pattern within an “empty vehicle seat.” This differentiation arises due to the presence on “occupied” seats of many edges defined by differently oriented planes intersecting, such as from planes corresponding to folds in clothing worn by the occupant, or curved lines where portions of the occupant's body join together (e.g., where arms meet ones body) as compared to the distinct edges typically associated only with stitching on a vehicle seat. Thus, more variation in spatial orientation throughout a key region is indicative of the presence of an object or occupant on an otherwise generally smooth surface (e.g., portion of a vehicle seat that has variations typically only where stitching is present on the vehicle seat). In the case of an “occupied” seat, the histogram will appear broader and uniformly distributed as compared to those narrow and focused histograms associated with an “empty” seat.

When determining overall classification of a position with the vehicle, such as when classifying a vehicle seat as being “empty” or “occupied,” results of pattern recognition from one or more key regions are used. Any suitable method can be used for overall classification based on the data obtained from the use of wavelet transforms in each key region according to the present methods and apparatus. For example, results of pattern recognition for multiple regions can be used in a voting process to arrive at an overall classification for the seat-“empty” or “occupied.” According to an exemplary voting process, each key region is assigned a relative weight as compared to the other key regions. As an example, the vehicle seat bottom can be assigned relatively less weight than the vehicle seat back, due to the likelihood that any inanimate object occupying the seat (e.g., purse, documents, and the like) will be located on the bottom of the seat, if at all.

The methods and apparatus described in the exemplary embodiments herein accumulate information about a position within a vehicle and process that information to assign an occupancy classification to the position. The methods and apparatus function to provide a highly accurate classification of the vehicle occupancy (including an identification that the position is “empty” when there is no animate form in that position) and, therefore, the methods and apparatus are advantageous as compared to previous occupancy classification systems.

As used herein, the term “image-based sensing equipment” includes all types of optical image capturing devices. The captured images may comprise still or video images. Image-based sensing equipment include, without limitation, one or more of a grayscale camera, a monochrome video camera, a monochrome digital complementary metal oxide semiconductor (CMOS) stereo camera with a wide field-of-view lens, or literally any type of optical image capturing device.

According to one exemplary embodiment, image-based sensing equipment is used to obtain image information about the environment within a vehicle and its occupancy. The image information is analyzed and classified in accordance with the present teachings. Analysis and classification according to the exemplary embodiment generally occurs using any suitable computer-based processing equipment, such as that employing software or firmware executed by a digital processor.

Those skilled in the art will appreciate that the disclosed method and apparatus may be practiced or implemented in any convenient computer system configuration, including hand-held devices, multiprocessor systems, microprocessor-based or programmable consumer electronics, networked personal computers, minicomputers, mainframe computers, and the like. The disclosed methods and apparatus may also be practiced or implemented in distributed computing environments where tasks are performed by remote processing devices linked through a communications network. In a distributed computing environment, program modules may be located in both local and remote memory storage devices.

Various modifications and alterations of the disclosed methods and apparatus will become apparent to those skilled in the image processing arts without departing from the spirit and scope of the present teachings, which is defined by the accompanying claims. The appended claims are to be construed accordingly. It should also be noted that steps recited in any method claims below do not necessarily need to be performed in the order that they are recited. Those of ordinary skill in the image processing arts will recognize variations in performing the steps from the order in which they are recited.

1. A computer system comprising an algorithm for processing of imagery associated with a position to be analyzed, wherein the imagery is processed to classify occupancy of that position, and wherein the algorithm utilizes a wavelet transform in processing of the imagery.

2. The computer system of claim 1, wherein the algorithm uses spatial filtering for processing of the imagery.

3. The computer system of claim 1, wherein the wavelet transform comprises at least one Gabor filter.

4. The computer system of claim 1, wherein the position is classified as being empty or occupied as a result of processing the imagery.

5. The computer system of claim 1, wherein processing of the imagery comprises using statistical analysis of feature vectors derived from the wavelet transform.

6. The computer system of claim 5, wherein the statistical analysis comprises use of histograms, wherein histograms associated with classification of the position as empty are narrow and focused as compared to histograms being associated with classification of the position as occupied, which are broader and more uniformly distributed.

7. The computer system of claim 1, wherein the position comprises a vehicle seat.

8. An automated safety system comprising a computer system, wherein the computer system comprises:
an algorithm for processing of imagery associated with a position to be analyzed, wherein the imagery is processed to classify occupancy of that position, and
wherein the algorithm utilizes a wavelet transform in processing of the imagery.

9. The automated safety system of claim 8, wherein the system comprises an airbag deployment system.

10. The automated safety system of claim 8, comprising image-based sensing equipment.

11. The automated safety system of claim 8, comprising an electronic control unit for selective deployment of safety equipment.

12. The automated safety system of claim 11, wherein the safety equipment comprises an airbag.

13. A method for classification of occupancy at a position, the method comprising steps of:
obtaining an image of the position for use in classification of the occupancy at that position;
optionally segmenting the image at the position;
optionally dividing the image into multiple key regions for further analysis;
analyzing texture of the image using one or more wavelet transforms; and
classifying occupancy of the position based on the texture of the image.

14. The method of claim 13, wherein the step of analyzing texture of the image comprises using a bank of Gabor filters.

15. The method of claim 13, wherein Gabor filter coefficients from the bank of Gabor filters are used to form a feature vector.

16. The method of claim 15, wherein statistical analysis is performed on the feature vector.

17. The method of claim 16, wherein the statistical analysis comprises use of histograms, wherein histograms associated with classification of the position as empty are narrow and focused as compared to those histograms associated with classification of the position as occupied, which are broader and more uniformly distributed.

18. The method of claim 13, further comprising transmitting information associated with the classification to an electronic control unit.

19. The method of claim 18, wherein the electronic control unit comprises an airbag controller.

20. The method of claim 13, wherein the position is a seat within a vehicle.

21. The method of claim 13, wherein the occupancy of the position is assigned a classification of “empty” or “occupied.”
